(19) United States
(12) Patent Application Publication
(10) Pub. No.: US 2005/0260997 A1
(43) Pub. Date: Nov. 24, 2005

(54) Resource management apparatus and a method of resource management therefor

(76) Inventors: Asoka Korale, Leatherhead (GB); Stephen Barrett, Thatcham (GB)

Correspondence Address: MOTOROLA, INC., 1303 EAST ALGONQUIN ROAD, IL01/3RD, SCHAUMBURG, IL, 60196, US

(21) Appl. No.: 10/528,758

(22) PCT Filed: May 23, 2003
(86) PCT No.: PCT/EP03/05505

§ 371 Date: Mar. 18, 2005

(30) Foreign Application Priority Data
Sep. 27, 2002 (GB) 0222459.0

(51) Int. Cl. H04Q 7/20; H04M 1/00; H04B 1/38

(52) U.S. Cl. 455/452.2; 455/560

(57) ABSTRACT

A resource management apparatus for a cellular communication system is provided wherein the available radio resource is divided into separate partitions, each of which is allocated to a different operator, such as a Mobile Virtual Network Operator. Radio Network Controllers of the cellular communication system comprise independent resource controllers for each operator. The resource controllers allocate radio resource to a subscriber unit in response to an operator identity associated with a service of the subscriber unit, such that different quality of service is achieved for different operators. The resource is allocated from the resource partition of the operator identified. The resource controllers independently control one or more quality of service parameters of the radio access network, Hence, each operator may independently control and manage quality of service and is thereby enabled to differentiate from other operators.

### FIELD OF THE INVENTION

The invention relates to a resource management apparatus and a method of resource management therefor, and in particular to a resource management system for a cellular communication system such as UMTS.

### BACKGROUND OF THE INVENTION

FIG. 1 illustrates the principle of a conventional cellular communication system 100 in accordance with prior art. A geographical region is divided into a number of cells 101, 103, 105, 107 each of which is served by base station 109, 111, 113, 115. The base stations are interconnected by a fixed network which can communicate data between the base stations 101, 103, 105, 107. A mobile station is served via a radio communication link by the base station of the cell within which the mobile station is situated. In the example if FIG. 1, mobile station 117 is served by base station 109 over radio link 119, mobile station 121 is served by base station 111 over radio link 123 and so on.

As a mobile station moves, it may move from the coverage of one base station to the coverage of another, i.e. from one cell to another. For example mobile station 125 is initially served by base station 113 over radio link 127. As it moves towards base station 115 it enters a region of overlapping coverage of the two base stations 111 and 113 and within this overlap region it changes to be supported by base station 115 over radio link 129. As the mobile station 125 moves further into cell 107, it continues to be supported by base station 115. This is known as a handover or handoff of a mobile station between cells.

A typical cellular communication system extends coverage over typically an entire country and comprises hundred or even thousands of cells supporting thousands or even millions of mobile stations. Communication from a mobile station to a base station is known as uplink, and communication from a base station to a mobile station is known as downlink.

The fixed network interconnecting the base stations is operable to route data between any two base stations, thereby enabling a mobile station in a cell to communicate with a mobile station in any other cell. In addition the fixed network comprises gateway functions for interconnecting to external networks such as the Public Switched Telephone Network (PSTN), thereby allowing mobile stations to communicate with landline telephones and other communication terminals connected by a landline. Furthermore, the fixed network comprises much of the functionality required for managing a conventional cellular communication network including functionality for routing data, admission control, resource allocation, subscriber billing, mobile station authentication etc.

The frequency band allocated for a cellular communication system is typically severely limited, and therefore the resource must be effectively divided between mobile stations. A fundamental property of a cellular communication system is that the resource is divided geographically by the division into different cells. Thus a certain amount of resource (for example a frequency band) may at a given time be allocated to a given cell thereby reducing the resource allocation to neighbouring cells. In order to optimise the capacity of a cellular communication system, it is important to minimise the impact of interference caused by or to other mobile stations.

Currently the most ubiquitous cellular communication system is the 2^{nd} Generation system known as the Global System for Mobile communication (GSM). Similarly to analogue systems, the frequency band is divided into relatively narrow channels of 200 kHz and each base station is allocated one or more of these frequency channels. However, in contrast to the analogue systems, each frequency channel is divided into eight separate time slots allowing up to eight mobile stations to use each frequency channel. This method of sharing the available resource is known as Time Division Multiple Access (TDMA). Further description of the GSM TDMA communication system can be found in ‘The GSM System for Mobile Communications’ by Michel Mouly and Marie Bernadette Pautet, Bay Foreign Language Books, 1992, ISBN 2950719007.

Another principle of resource distribution is employed in the 2^{nd} generation system known as IS95, as well as in 3^{rd} Generation systems such as the Universal Mobile Telecommunication System (UMTS). These systems divide the frequency into one or few wide band channels, which for UMTS has a bandwidth of 5 MHz. Typically, one wide band frequency channel is used for uplink in all cells and a different wide band frequency channel is used for downlink. In this case, separation between cells is achieved through the use of spread spectrum techniques, where each cell is allocated a cell specific long user spreading code.

In these systems, a signal to be transmitted is multiplied by the spreading code, which has a chip rate typically much larger than the data rate of the signal. Consequently, a narrowband signal is spread over the wideband frequency channel. In the receiver, the received signal is multiplied by the same spreading code thereby causing the original narrowband signal to be regenerated. However, signals from other cells having a different spreading code are not despread by the multiplication in the receiver, and remain wideband signals. The majority of the interference from these signals can consequently be removed by filtering of the despread narrowband signal, which can then be received.

Separation between mobile stations of the same cell is also achieved by use of spread spectrum techniques. The signal to be transmitted is multiplied by a shorter user specific code. Similarly, the receiver multiplies the received signal with the user specific code, thereby recovering the originally transmitted signal without despreading signals from any of the other mobile stations. Thus, the interference from all other mobile stations, whether in the same or a different cell, can effectively be reduced by filtering.

A consequence of the spread spectrum techniques employed is that the amount of the interfering signals, which fall within the bandwidth of the narrowband signal cannot be removed by filtering, and will thus reduce the signal to interference ratio of the received signal. Consequently, it is of the outmost importance that the interference between mobile stations is optimised in order to maximise the capacity of the system. The reduction of the interference from an unwanted mobile station is equal to the ratio between the bandwidth of the spread signal and the narrowband despread signal, equivalent to the ratio between the chip rate and the symbol rate of the transmitted signal. This ratio is known as the processing gain. The technique is known as Code Division Multiple Access (CDMA), and further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876.

A very important factor in a communication system is the quality of service that a user is provided with. In traditional communication systems, which were strongly focussed on the service of providing speech services, such quality of service parameters mainly related to the speech quality and probabilities of setting up and maintaining calls. However, in the further development of GSM and in related communication systems such as General Packet Radio Service (GPRS) and 3^{rd} generation systems, an increased variety of services are offered and envisaged. These services may for example include high data rate real time services or low data rate non-delay sensitive data communication, such as for example email. Consequently, the quality of service requirements vary widely between different users and services, and the ability to meet a variety of quality of service parameters have become of increasing importance.

Conventionally, each cellular communication system is owned and operated by a network operator. The network operator controls the operation and maintenance of the communication system through centralised Operations and Maintenance Centres (OMCs). In addition various operational and resource controlling parameters may be set locally, such as at the base station, by the network operator. This operation allows the network: operator to control the communication system, and in particular the quality of service provided to the communication systems. In addition to the network operator, a communication system may be utilised by a Mobile Virtual Network Operator (MVNO). The MVNO basically operates as a reseller of the services of the cellular communication system and may thus independently advertise and sell the services of the network. This provides for a business model wherein different segments of the market may be addressed by different network operators and MVNOs.

Differentiation between different MVNOs and network operators is predominantly by means of advertising, distribution means, sale channels and image control. However, some differentiation may also be achieved through customer support or at the billing level, for example by operating a different set of tariffs. However, an increased possibility of differentiation would be a distinct advantage.

### SUMMARY OF THE INVENTION

The Inventors of the current invention have realised that increased differentiation between operators of different networks is advantageous and may be achieved by controlling parameters differently for different operators. Accordingly the Invention seeks to enable an improved differentiation and in particular an increased differentiation in quality of service provided.

Accordingly there is provided a resource management apparatus for a cellular communication system; comprising a resource controller operable to allocate a radio resource to a subscriber unit in response to an operator identity associated with a service of the subscriber unit, such that different quality of service is achieved for different operators. Hence, the invention allows for different operators to differentiate on the quality of service provided to subscriber units. It further provides for each operator to control the quality of service parameters according to their specific preference.

According to a first feature of the invention, the cellular communication system has a common radio access network resource divided into a first partition for a first operator and a second partition for a second operator, and the resource controller is operable to allocate resource from the first partition if the operator identity corresponds to the first operator and from the second partition if the operator identity corresponds to the second operator. This enables a simple resource partitioning wherein each operator has an allocated resource that can be assigned and managed according to the specific quality of service preferences for that operator.

According to another feature of the invention, the resource management controller comprises: control means for independently controlling at least one quality of service parameter associated with the first partition of the common radio access network resource in response to a first preference parameter of the first operator, and at least one quality of service parameter associated with the second partition of the common radio access network resource in response to a second preference parameter of the second operator. Hence, two operators may independently control their allocated resource thereby allowing for a simplified control mechanism, increased individual control and improved possibility of quality of service differentiation.

Preferably the at least one quality of service parameter comprises at least one radio access network parameter chosen from the group of: a call blocking rate; a call drop rate; an error rate; a delay; a throughput fairness; and a power control target. Hence, preferably key quality of service parameters are controlled independently for different operators, thereby providing suitable parameters for differentiating between operators.

According to another feature of the invention, wherein the control means comprise a first quality of service controller for independently controlling the at least one quality of service parameter associated with the first partition and a second quality of service controller for independently controlling the at least one quality of service parameter associated with the second partition. This provides for a simple implementation wherein individual control and management of one or more quality of service parameters can easily be achieved.

According to a different feature of the invention, the first quality of service controller comprises first input means for receiving control input from the first operator and the second quality of service controller comprises second input means for receiving control input from the second operator. Preferably, each of the first and second quality of service controller has an individually associated operations and maintenance controller. This provides the advantage of each operator having direct and independent control of quality of service parameters.

According to another feature of the invention, the first quality of service controller comprises a first resource allocator for allocating resource associated with the first partition and the second quality of service controller comprises a second resource allocator for allocating resource associated with the second partition. The resource allocator preferably comprises traffic schedulers and additionally or alternatively admission controllers. Hence, scheduling and admission control may be under the individual control of each operator and operate according to the quality of service preferences of each operator. This provide for a highly efficient method of controlling resource and quality of service for each operator.

According to a different feature of the invention, the first quality of service controller comprises a first power control controller for controlling transmit powers associated with the first partition and the second quality of service controller comprises a second power control controller for controlling transmit powers associated with the second partition. Advantageously the power controls may thus be individually managed by different operators thus providing a highly accurate and efficient control over quality of service parameters such as for example an air interface error rate.

According to another feature of the invention, the control means is operable to control the at least one quality of service parameter associated with the first partition and the at least one quality of service parameter associated with the second partition in response to at least one common parameter for the first and second partition. Preferably, the at least one common parameter is a total resource usage for the first and second partition. This allows for common characteristics and operating conditions to be taken into account ensuring a high performance of the whole communication system and ensuring that the combined effect of the individual control results in suitable overall performance.

According to a different feature of the invention, the partitioning of resource in said first and second partition is different in different regions. This allows for optimisation of the resource partition in accordance with the demographics of the users for each operator.

According to another feature of the invention, the resource management apparatus comprises means for dynamically varying the partitioning of resource into said first and second partition, and preferably the partitioning of resource into the first and second partition is in response to a resource usage in said first and second partition. This provides the advantage of allowing for the resource allocation to each operator to be optimised for the changing operating conditions.

Preferably the radio resource is a frequency resource, a code resource and/or a power resource.

According to a second aspect of the invention, there is provided a cellular communication system comprising a resource management apparatus.

According to a third aspect of the invention, a method of resource management in a cellular communication system; comprising allocating a radio resource to a subscriber unit in response to an operator identity associated with a service of the subscriber unit, such that different quality of service is achieved for different operators. Preferably, the cellular communication system has a common radio access network resource divided into a first partition for a first operator and a second partition for a second operator and the step of allocating a radio resource comprises allocating resource from the first partition if the operator identity corresponds to the first operator and from the second partition if the operator identity corresponds to the second operator and the step of allocating a radio resource comprises independently controlling at least one quality of service parameter associated with the first partition of the common radio access network resource in response to a first preference parameter of the first operator, and at least one quality of service parameter associated with the second partition of the common radio access network resource in response to a second preference parameter of the second operator.

### BRIEF DESCRIPTION OF THE DRAWINGS

An embodiment of the invention will be described, by way of example only, with reference to the drawings, in which

FIG. 1 is an illustration of a cellular communication system in accordance with the prior art; and

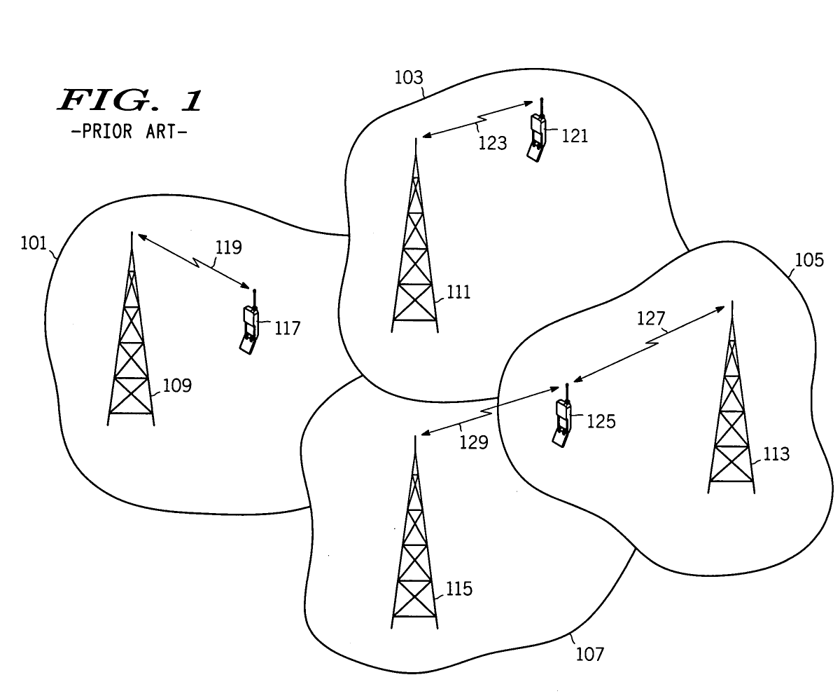

FIG. 2 is an illustration of a cellular communication system in accordance with an embodiment of the invention.

### DETAILED DESCRIPTION OF A PREFERRED EMBODIMENT OF THE INVENTION

In the following, a preferred embodiment of the invention is described mainly with reference to a UMTS cellular communications system. However, it will be apparent that the invention is applicable to many other communication systems including for example GSM and other 3^{rd} Generation cellular communication systems.

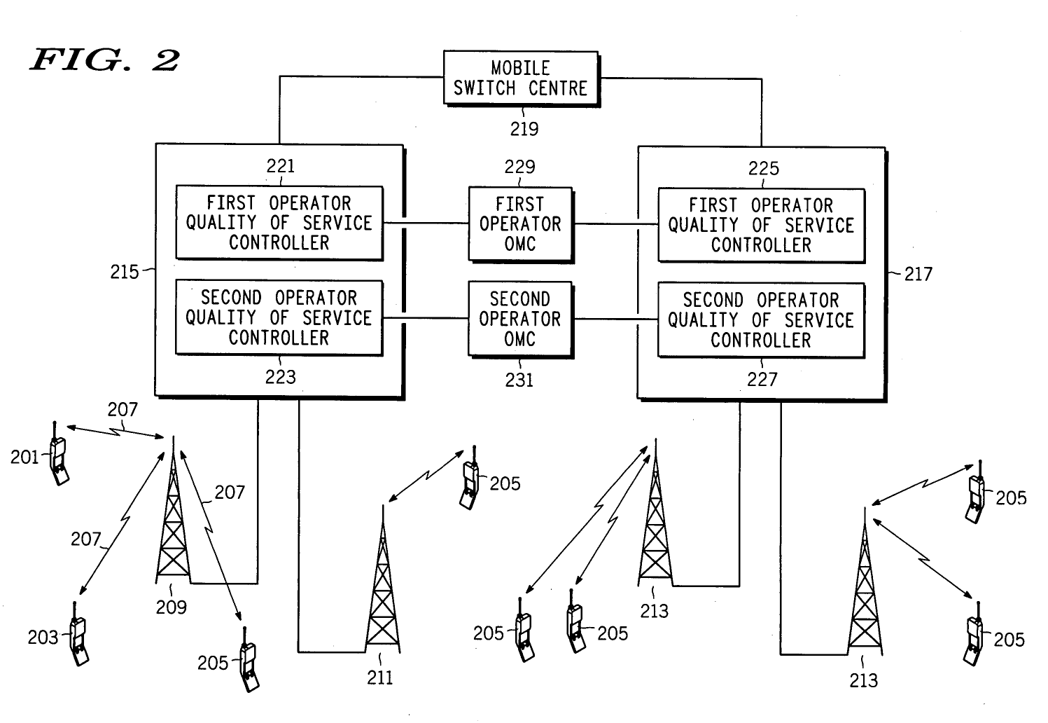

FIG. 2 is an illustration of a cellular communication system 200 in accordance with a preferred embodiment of the invention. In the communication system 200, a number of subscriber units 201, 203, 205 communicate over air interfaces 207 to serving base stations 209, 211, 213. A subscriber unit may typically be a wireless user equipment, a mobile station, a communication terminal, a personal digital assistant, a laptop computer, an embedded communication processor or any communication element communicating over the air interface.

In the illustrated example, two base stations 209, 211 are connected to a first radio network controller (RNC) 215 whereas two other base stations 213 are connected to a second radio network controller 217. In a UMTS CDMA communication system, the communication network comprises a core network and a Radio Access Network (RAN). The core network is operable to route data from one part of the RAN to another, as well as interfacing with other communication systems. In addition, it performs many of the operation and management functions of a cellular communication system, such as billing. The RAN is operable to support wireless user equipment over a radio link being part of the air interface. The RAN comprises the base stations, which in UMTS are known as Node Bs, as well as Radio Network Controllers (RNC) which performs many of the control functions related to the air interface including radio resource management and routing of data to and from appropriate base stations. It further provides the interface between the RAN and the core network. An RNC and associated base stations are known as a Radio Network System (RNS). Specifically, the RNCs are responsible for much of the air interface resource management and specifically control admission, scheduling and handovers.

In FIG. 2 each of the RNCs 215, 217 are connected to a Mobile Switch Centre (MSC) 219, which is a central switch centre that switches communication between different RNCs 215, 217 such that subscriber units 201, 203, 205 connected to one RNC can communicate with subscriber units 201, 203, 205 of another RNC. In addition, the MSC 219 is responsible for interfacing with other networks, performing authentication, some mobility management etc.

In the described preferred embodiment, the first RNC 215 comprises a first operator Quality of Service (QoS) controller 221, which performs the RAN management for the subscriber units associated with a first operator of the communication system. In addition, the first RNC 215 comprises a second operator QoS controller 223, which performs the RAN management for the subscriber units associated with a second operator of the communication system. Likewise, the second RNC 217 comprises a QoS controller 225 for subscriber units associated with the first operator, and a QoS controller 227 for subscriber units associated with the second operator.

The first operator QoS Controllers 221, 225 are both connected to a first operator Operation and Maintenance Centre (OMC) 229 from which the operation of the first operator QoS Controllers 221, 225 can be controlled. Likewise, the second operator QoS Controllers 223, 227 are both connected to a second operator OMC 231 from which the operation of the second operator QoS Controllers 223, 227 can be controlled. For clarity, the connection is illustrated directly from the QoS Controllers 221, 223, 225, 227 in the RNCs 215, 217 to the first and second operator OMCs 229, 231. However, in UMTS communication systems, the OMCs are typically connected to an MSC, and the connection between the RNCs and the OMCs is through an appropriate MSC. Therefore, in many implementations, the connection between the RNCs and the OMCs are logical connections rather than direct physical connections.

In the preferred embodiment, the communication system comprises a resource management apparatus wherein a resource controller is operable to allocate a radio resource to a subscriber unit in response to an operator identity associated with a service of the subscriber unit, such that different quality of service is achieved for different operators. In the specific example of FIG. 2, the resource management apparatus comprises the QoS controllers of one or both of the RNCs. The resource allocation is not necessarily a direct and dedicated allocation of a given resource but is preferably indirect in setting a QoS parameter thereby affecting the resource usage of that subscriber unit. For example, a resource may be allocated by setting a desired air interface error rate as the transmit power, and thus a power and interference resource, is affected by this parameter.

In accordance with an embodiment of the invention, the quality of service differentiates between different operators. In some embodiments the differentiation in QoS parameters may be controlled by a single resource controller that manages subscriber units for both operators in such a way that the QoS is different for the two operators. Specifically, a central resource controller may receive identity information for each subscriber unit requesting to setup a service, Depending on the identity, the central resource controller may set the service up with different parameters. Thus if the call is associated with the first operator, the central resource controller may set up the service with a specific maximum delay and minimum data throughput. However, if the service is associated with the second operator the service may be set up with a different delay and throughput. For example, if the central resource controller receives a request for a video communication service to be set up, it may allocate a data rate of 32 kbps if the associated identity corresponds to the first operator, but only 16 kbps if the identity corresponds to the second operator. Thus in this embodiment, the resource controller, which may be an RNC, sets a QoS parameter for a service provided to a subscriber unit in response to the identity of the operator associated with that subscriber unit. The QoS parameter may be set directly or the resource controller may for example set another parameter that will affect the QoS of the service.

As illustrated in FIG. 2, the RAN is in the preferred embodiment of the invention shared between the first and second (and any further) operators. Thus, preferably, the same base stations and RNCs are used to communicate with subscriber units associated with the first operator and subscriber units associated with the second operator. The association is preferably determined by which operator the individual subscriber unit has entered into an agreement with or has procured a service from, but any suitable association between subscriber units and operators may be used. Typically, users of cellular communication systems enter into an agreement with a single operator. The single operator provides the required services as well as further customer services such as billing etc. In the preferred embodiment, any service or call setup is associated with signalling that includes the identity of the operator. For example, when a speech call is set up, the identity of the subscriber unit is used to authenticate the user and for charging the user. For this reason, a central register comprising subscriber unit information is accessed (such as a Home Location Register (HLR)), and as part of this access the operator identity associated with the user may be derived and passed to the resource controllers.

In the preferred embodiment, the first operator is a cellular communication system operator and the second operator is a Mobile Virtual Network Operator (MVNO). In this embodiment the cellular communication system operator typically owns the communication system and has the overall responsibility for and control over the communication system whereas the MVNO provides services to users by using the cellular communication system. It is expected, that an existing mobile service operator will seek partnership with a Mobile Virtual Network Operator in the provision of services with the intent of gaining additional overall market share from other mobile service operators, to penetrate new market segments or segments that the operator has found difficulty in accessing, to share the costs of deployment and to obtain additional revenue on any spare capacity that might be available. MVNO's may bring certain core competencies in content provision, applications development, customer care and marketing together with a strong brand image to the partnership making it a mutually beneficial arrangement. Hence, in accordance with the preferred embodiment, an operator (such as an owner of 3 G spectrum) and a Mobile virtual network operator (MVNO) are able to differentiate themselves on the provided radio resource quality of service. QoS differentiators could include: call blocking rate, call dropping rate, frame erasure rate, packet call completion delay etc.

Although the operators in the preferred embodiment provide a range of services over a large area, operators are more generally any entity that provide, enable or facilitate a service via the cellular communication system. As such, a content provider of one or more services may be an operator. Likewise, a portal to the internet and or an internet service provider using the cellular communication system may in some embodiments be considered an operator. Further, in the preferred embodiment, the first and second operators are semi-permanent operators which operate respective services over the communication system for an extended period of at least a few months and typically several years. However, in other embodiments, the operators associated with a cellular communication system may vary dynamically, and specifically an operator may simply be an operator for the duration of a specific service provided.

The resource management apparatus may control and manage any suitable resource or combination of resources. In the preferred embodiment, the resource controller is primarily an interference or power resource. In a cellular communication system, such as UMTS, the capacity of the communication system is limited by the interference between subscriber units and base stations. The control and management of the interference resource is subject to a number of trade offs and can be performed in accordance with many different algorithms. In the preferred embodiment, this resource is differently controlled for different operators, thereby allowing each operator to make different trade-offs and use different algorithms and criteria. As the interference is typically the result of the transmit powers used in the communication system, the interference is preferably controlled by controlling the transmit powers of the subscriber units and base stations of the communication system, either directly or indirectly by setting other parameters. Hence, as a specific example, a subscriber unit may be assigned a given error rate depending on which operator it is associated with. As a higher transmit power, and thus increased interference, is required to achieve a lower error rate, this allows the trade off between QoS and resource usage to be individually controlled for different operators.

In other embodiments, the resource controlled is a frequency resource or a code resource. The latter is especially suitable for a 3^{rd} generation communication system by allowing for independent trade-offs between QoS and the usage of codes. For example, the first operator may choose to use a longer code for a given data rate than a second operator. This provides for reduced sensitivity to interference and reduced error rates but also reduces the capacity (in terms user data rates) of the communication system.

In the preferred embodiment, the cellular communication system has a common radio access network resource divided into a first partition for the first operator and a second partition for the second operator, and the resource controller allocates resource from the first partition if the operator identity corresponds to the first operator and from the second partition if the operator identity corresponds to the second operator. In the preferred embodiment, the operator and MVNO may thus arrange for a certain resource partition to be for the subscriber units associated with the first operator, and a second resource partition to be for the subscriber units associated with the second operator. This provides for a simple separation of resource between the different operators and allows each operator to manage its resource partition substantially independently or at least detached to some degree from the resource management of the other operators.

In accordance with the embodiment, the partnership between a communication system operator and an MVNO may consist of an a-priori partitioning of the radio and/or core network resources. Thereby each of the operators has a guaranteed minimum share of resources that they have access to. The resource partition size may be determined and agreed in terms of one or more of the limited resources in a UMTS network, such as for example the base station transmit power and code resource. Thereby, a pre-assignment occurs of resource capacity between the operators in a network, and consequently each operator may control the resource of the allocated partition independently of the other operators. Hence, in the preferred embodiment, the resource management controller comprises a controller which independently controls QoS parameter(s) for the first and second resource partition in response to a preference of the first and second operator respectively. Once a partition of the radio resource has been made, each operator may use the allocated resource independently of the other operator(s), and in any manner that does not interfere with the resource usage of the other partition.

The resource which is divided into the first and second partition is a shared radio resource, which in the example of FIG. 2 is associated with equipment shared between the first and second operator. Hence, in terms of a resource being that of available CDMA codes, a given base station may be allocated a given code tree. This code tree may then be divided such that a given set of the available codes are allocated to a first operator to use and a given set is allocated to a second operator to use.

As a specific example of a UMTS embodiment in accordance with FIG. 2, two subscriber units 201, 203 may access the communication system through the base station 209 to set up an Internet browsing service. The first subscriber unit 201 is a subscriber of the cellular communication system operator and the second subscriber unit 203 is a subscriber of a MVNO using the communication system. The base station 209 detects the identity of the subscriber units 201, 203 and through the RNC 215 transmits this information to the MSC 219. The MSC 219 accesses a data register (not shown) to authenticate the subscriber units 201, 203. In addition, it retrieves a pre-stored operator identity which for the first subscriber unit 201 corresponds to the communication system operator and for the second subscriber unit 203 corresponds to the MVNO. The information is communicated back to the RNC 215, which comprises a resource management controller that has functionality for setting up the requested Internet browsing service. Hence, the communication system comprises information for associating the operator identity to a service of a subscriber unit when initiating the service.

In UMTS the information passed from the core network to the RNC at call setup comprises a QoS descriptor which includes a number of QoS parameters that are appropriate for the service being setup. In the example, this QoS descriptor is identical for the two subscriber units 201, 203. However, in the resource management controller of the RNC the two service set ups are treated independently. The service for the first subscriber unit 201 is set up by allocating some resource from the first partition. For example, the service of the first subscriber unit 201 may be set up with a list of QoS parameters that correspond to those in the QoS descriptor received from the core network.

In the example, the MVNO may be differentiating itself as a premium service operator where an improved quality of service is provided at an increased cost. Consequently, the resource management controller sets up the service for the second subscriber unit 203 with a list of QoS parameters that are improved with respect to those in the standard QoS parameter. Specifically, it modifies at least some of the QoS parameters of the QoS descriptor, such as the relative priorities, delays, error rates etc. As a specific example, the resource management controller may reduce the maximum delay and error rate by a factor of two thereby providing a faster and more reliable Internet browsing service than for the first operator but at a higher cost. Hence, the MVNO is able to differentiate itself from the cellular operator on the basis of the provided quality of service. It is therefore better equipped for targeting a specific segment of the market.

It is within the contemplation of the invention, that any suitable quality of service parameter may be used. A quality of service parameter includes all parameters that may directly or indirectly affect the quality of service for one or more subscriber units. As such, the QoS parameter is preferably a RAN parameter and in the preferred embodiment, it is one or more of the in the following described parameters.

Call Blocking Rate:

The resource management apparatus may independently control the call blocking rate (or service blocking rate) dependent on the identity of the operator.

For example, an operator may decide to admit an additional subscriber unit on to the network by moving a portion of the currently active subscriber units to lower resource demanding bearers, e.g. bearers having lower data rates. This situation arises when there is no additional power or code resource available for new subscriber units. However, another operator may simply decide to block new calls and maintain the existing quality of service level for the currently active subscriber units. In this way, each operator is able to offer different blocking rates by trading off the quality of service seen by users currently on the network in favour of providing service to a new user.

A particular call or service blocking rate may be achieved by the decisions made by an admission control algorithm and a scheduling algorithm. Hence, the differentiation is enabled by an independent operation of the queue disciplines and schedulers for the different operators.

The implementation of a particular blocking strategy will be dependent on the type of services of a particular operator. A network that guarantees streaming video or high quality circuit switched traffic will not be able to degrade service to existing users in favour of a lower blocking rate in times of high load or network congestion. If on the other hand the overall objective is to provide delay insensitive services such as web browsing, to as many users as possible, a trade off may be acceptable.

Call Drop Rate:

Similarly to the call blocking rate, each individual operator may desire to independently control the call drop rate. The call drop rate may for example be traded off against the resource utilisation, and in accordance with the described embodiment, this trade-off may be independently traded off in response to each operators individual preference, thereby permitting further differentiation.

Delay

Another important parameter that is preferably independently controlled is the delay of a data transmission. This is particularly suitable for packet communication.

Specifically, a packet call delay is directly dependent on the assigned data rate. Additionally for systems such as UMTS that use an Automatic Repeat Request (ARQ) scheme, wherein packets received in error are retransmitted, the delay increases for increasing error rates as more retransmissions are required. The error rate is affected by the SIR target and therefore the transmit power allocated to the communication link. Consequently, the delay of the service may be controlled by the power allocation for the service. However, increased transmit power results in an increased resource consumption and the individual operator may thus trade off delay and resource consumption according to its preference.

As another example, the delay is typically also dependent on how often packet transmission from a given subscriber unit is scheduled, and therefore independent scheduling for the different operators enable differentiation in terms of throughput delay.

Throughput Fairness

In a CDMA communication system such as UMTS the resource required for supporting a specific service depends on the radio conditions for the subscriber unit. For example, in the downlink, increased transmit power is required to support the same service for a subscriber unit further removed from the base station. This results in increased interference and thus increased resource usage. Hence, the communication system may prefer to support closer subscriber units than farther subscriber units. However, in order to provide a fairer service wherein all subscriber units are provided with suitable services, the communication system will typically not just be in terms of the required resource, but also include a fairness parameter that can adjust the relative preference of subscriber units in response to the radio conditions experienced, and in particular the path loss between subscriber unit and the base station.

In the preferred embodiment, each operator may individually control the level of the throughput farness between subscriber units. Thus, depending on the operator's preferences, the allocation of resources in response to the required service request and the distance between the subscriber unit and the base station may be independently performed. Thus the operator can trade overall cell throughput versus fairness (where fairness could most simply be viewed in terms of the range of throughput achieved across subscriber units)

Power Control Target

The operators may independently control the performance of the power control loop and thereby allow a trade off between the achieved error rates and resource consumption.

In UMTS, both an inner power control loop and an outer power control loop are implemented. Inner loop power control operates as follows. The receiving entity of a radio link measures the received signal to noise ratio (SIR), and compares it to a locally stored target SIR. A command is sent back to the transmitter to increase transmitted power if the measured SIR is less than the target. Conversely, if the measured SIR is greater than the target, a command is sent to the transmitter to decrease the transmitted power. The target SIR is set by the outer loop power control. Its function is to maintain the frame error rate (FER) of the radio link at or below a given value or threshold. The frame error rate of the received signal is measured by one of a number of known techniques, and the SIR target is adjusted to try to ensure that the FER is at or below the given value. Hence, in the preferred embodiment, each operator may independently set the FER target for the outer power control loop.

Error Rate:

An important QoS parameter is the error rate that can be achieved over the air interface, and therefore the ability for each operator to individually control the error rates provide a significant advantage. The error rate controlled may be the coded or uncoded channel bit error rate, but is in the preferred embodiment the frame erasure rate of the communication system.

The error rates are directly affected by the interference levels and the transmit power allocated to the communication link. This power allocation is in a typical UMTS system limited by a maximum power level per code. However, preferably this setting is common to all operators and is not individually controlled by the operator as it may be required for the protection of the radio equipment.

However, the outer loop power control operates within the subscriber unit and adjusts the signal to interference ratio (SIR) target that the fast power control loop uses in order to meet a particular error rate. The range of values that this target may take and the incremental steps by which the target is increased or decreased will determine how quickly fast power control adjusts in a situation where the interference conditions are changing rapidly. As a result, both the SIR target range and the step size determine the quality of the connection. In the preferred embodiment, these parameters may be individually controlled by each operator.

Likewise, the number of users served per frame and their scheduled transmit powers are quantities that can be independently managed by each operator. These in turn determine the intra cell interference seen by the users.

Another approach to meeting a particular error rate would be to use the queue discipline and admission control algorithms to serve only those subscriber units that have good interference conditions and deny admission or drop subscriber units which are on average below a certain threshold SIR. This scenario trades unfairness (amount of throughput as a function of path loss) and a higher blocking rate for delivering a certain maximum error rate to those users on the network.

Preferably, these schemes ensure that enough power is transmitted to meet the SIR target (even in a fast changing interference environment) and thereby meet a particular target error rate. This is achieved under the constraint of the maximum power per code limits so that the overall communication system is not overloaded.

In the preferred embodiment, the resource controller comprise a first quality of service controller 221 for independently controlling at least one quality of service parameter associated with the resource partition of the first operator and a second quality of service controller 223 for independently controlling at least one quality of service parameter associated with the resource partition of the second operator. Thus as illustrated in FIG. 2, each RNC 215 comprises two QoS controllers 221, 223 which operate independently of each other in controlling QoS parameters of the first and second operator respectively.

Further, in the preferred embodiment, the first quality of service controller comprises an input for receiving control input from the first operator, and the second quality of service controller comprises an input for receiving control input from the second operator. Any suitable method and mechanism for receiving inputs may be implemented but in the preferred embodiment, each QoS controller has an individually associated operations and maintenance controller. Thus, as shown in FIG. 2, the first QoS controller 221 is connected to an OMC 229 for the first operator, and the second QoS controller is connected to a second OMC 231 for the second operator. The OMCs are additionally connected to other respective QoS controllers in other RNCs. Hence, in the preferred embodiment, each MVNO may be provided with an OMC and its own RAN related OMC interface. Thus, the MVNO has independent control over significant parameters and characteristics of the communication system. Each operator is able to control the performance of his resource partition by controlling one or more QoS parameters. The provision of central OMCs provides for a convenient and practical means for controlling the whole or large parts of the communication system.

Although the QoS controllers independently set QoS parameters and control resource within each of the allocated resource partitions, they will in the preferred embodiment not operate in complete isolation. Specifically, the QoS controller may operate under various imposed restrictions. This allows for the total performance of the communication system to be controlled, such that e.g. the resource management by one QoS controller does not unacceptably impair the performance in the second resource partition. Specifically, the resource controller is operable to control the QoS parameters associated with the first partition and the second partition in response to at least one common parameter for the first and second partition. This parameter may for example be the maximum power allocation per code or a maximum power per cell parameter. Specifically, the common parameter may be a total resource usage for the first and second partition.

In the preferred embodiment, the communication system comprises a control mechanism that is independent of the operators and ensures that the combined resource being managed stays within the licensed spectrum and emission limits. It further ensures correct operation of the shared equipment e.g. by limiting the maximum total power transmitted by a base station to that which can be generated by the power amplifier of the transmitter. Additionally, the control mechanism may include consideration of parameters such as overload control, admission control, and error handling. Preferably the control mechanism controls the QoS controllers by setting a number of restrictive parameters within which the QoS controllers have to operate. Specifically, the radio resource apportioned between the operators is also constrained by certain algorithms running within the RNC and the base station. These algorithms ensure the correct operation of radio and amplifier equipment located within the base station. The constraints are enforced by the limits set in a configurable parameter list that resides within the RNC.

In addition to the independent operation of the QoS controllers, a common mechanism that has knowledge of the radio resource consumption by either operator and consequently of the total available capacity of the combined network is preferably operated. The common mechanism has knowledge of the rules governing the resource sharing and is therefore able to make a decision on admitting a new user with a specific QoS requirement into either partition. An algorithm that is particular to its own partition does not have global knowledge of the total interference conditions and the total available capacity of the network and can therefore be enhanced by the common mechanism.

In the preferred embodiment, two or more operators have access to a list of configurable OMC parameters that will allow it to offer differentiated services. The allocation of radio resource among users of a particular operator within the resource partition apportioned to that operator is independent of the other operators. Hence, the independent allocation of radio resource to subscriber units of each operator allows different priority handling for different traffic classes. The priority handling schemes may also be different for each operator. As an example, each operator has some independent control over the distribution of traffic allocated among the subscriber units and can therefore control the ‘fairness’ of the resource allocation, and specifically the amount of throughput allocated as a function of distance or path loss to the base station. Additionally, each operator may be able to change parameters that control the respective queue disciplines and schedulers via the OMC parameter settings, thereby changing the QoS for subscriber units of that operator.

In the preferred embodiment, the QoS controllers comprise resource allocators and specifically these include traffic schedulers. In this embodiment, different schedulers operate independently within each partition thereby allowing each operator to make different trade-offs e.g. in terms of overall system throughput as a function of distance from the base station. Specifically, the first and second operator may choose to use completely different types of queue disciplines in order to achieve different QoS experiences. Also, each operator may use separate algorithms for the scheduling, such as e.g. different algorithms for predicting the power required to serve a data packet. These algorithms will run within the respective scheduler. The prediction algorithm used may among other things depend on the particular type of traffic being served on each network and the degree to which each operator is conservative. The power prediction algorithm determines the amount of traffic that is scheduled in a frame, the networks interference contribution on the downlink and has an impact on whether traffic to a particular subscriber unit is scheduled at all.

Further, the different QoS controllers independently handle retransmissions of data packets in an ARQ scheme. Each operator may then independently take appropriate action regarding rescheduling of the data packets or terminating the connection and dropping the call altogether.

In the preferred embodiment the QoS controllers additionally or alternatively comprise independently operating admission controllers. These admission controllers may operate different algorithms for admitting a subscriber unit to the communication system and/or may perform the admission control in response to differently set admission control parameters.

Additionally or alternatively, the QoS controllers may comprise independent power control means. The power control algorithms may thus be different for different operators and/ or may be controlled by differently set power control parameters, such as the target frame erasure rate for a given service.

In some embodiments, the partitioning of available resource into resource partitions for each operator is semi-permanent and only changed very infrequently. However in other embodiments, the communication system may comprise functionality for dynamically varying the partitioning of resource into said first and second partition. It is within the contemplation of the invention, that the partitioning of resource may be in accordance with any suitable criterion, but preferably the partitioning is in response to a resource usage of each partition. As an example, if it is determined that a first operator frequently is operating at capacity and therefore is resource limited whereas a second operator never or only very rarely reaches full resource usage, the partitioning is modified such that the resource partition for the first operator is increased and the resource partition for the second operator is decreased. To facilitate this resource partition update, the communication system preferably comprises functionality for presenting relative usage levels of the first and second partition respectively.

Specifically for this embodiment, a mechanism is implemented for notifying the different operators of the actual partition resource usage statistics. This may further be linked into a billing system, for example to allow one operator to compensate another, if it is consistently using resource in excess of the agreed partition. Hence, the embodiment allows for one operator borrowing resource from another operator's partition under certain circumstances and according to certain rules, so as to improve utilisation/efficiency. Thus, for example, the scheduler of one operator may borrow resource from the other operator's partition under certain circumstances by communicating with the schedulers of other operators. This borrowing of resource may be associated with a cost compensation that may be pre-agreed. As another example, the partitioning of resource may also vary as a function of time.

In accordance with one embodiment of the invention, the partitioning of resource into the different resource partitions is different in different regions. Hence, preferably the communication system is operable to set the resource partition differently in different cells and/or geographic regions. Thus, the partition of radio resource enables the proportion of the shared resource allocated to each network, to vary depending on the particular base station, and therefore in a geographic sense. Each operator may thus have a higher or lower share of the common resource depending on the particular site.

The invention can be implemented in any suitable form including hardware, software, firmware or any combination of these. However, preferably, the invention is implemented as computer software running on one or more data processors. The elements and components of an embodiment of the invention may be located in the core network, the radio access network or any suitable physical or functional location. Indeed the functionality may be implemented in a single unit, in a plurality of units or as part of other functional units. As such, the invention may be implemented in a single unit or may be physically and functionally distributed in the network.

1. A resource management apparatus for a cellular communication system; comprising
a resource controller operable to allocate a radio resource to a subscriber unit in response to an operator identity associated with a service of the subscriber unit, such that different quality of service is achieved for different operators.

2. The resource management apparatus as claimed in claim 1 wherein the cellular communication system has a common radio access network resource divided into a first partition for a first operator and a second partition for a second operator, and the resource controller is operable to allocate resource from the first partition if the operator identity corresponds to the first operator and from the second partition if the operator identity corresponds to the second operator.

3. The resource management apparatus as claimed in claim 2, wherein the resource management controller comprises:
control means for independently controlling at least one quality of service parameter associated with the first partition of the common radio access network resource in response to a first preference parameter of the first operator, and at least one quality of service parameter associated with the second partition of the common radio access network resource in response to a second preference parameter of the second operator.

4. (canceled)

5. The resource management apparatus as claimed in claim 3, wherein the control means comprise a first quality of service controller for independently controlling the at least one quality of service parameter associated with the first partition and a second quality of service controller for independently controlling the at least one quality of service parameter associated with the second partition.

6-10. (canceled)

11. The resource management apparatus as claimed in claim 5 wherein the first quality of service controller comprises a first power control controller for controlling transmit powers associated with the first partition and the second quality of service controller comprises a second power control controller for controlling transmit powers associated with the second partition.

12. The resource management apparatus as claimed in claim 3 wherein the control means is operable to control the at least one quality of service parameter associated with the first partition and the at least one quality of service parameter associated with the second partition in response to at least one common parameter for the first and second partition.

13. (canceled)

14. (canceled)

15. The resource management apparatus as claimed in claim 2 wherein the resource management apparatus comprises means for dynamically varying the partitioning of resource into said first and second partition.

16. The resource management apparatus as claimed in claim 15 wherein the partitioning of resource into the first and second partition is in response to a resource usage in said first and second partition.

17. (canceled)

18. The resource management apparatus as claimed in claim 2 wherein both the first and second partition comprises resource associated with equipment shared between the first and second operator.

19-21. (canceled)

22. A cellular communication system comprising a resource management apparatus as claimed in claim 1.

23. A cellular communication system as claimed in claim 22 further comprising means for associating the operator identity to a service of a subscriber unit when initiating the service.

24. (canceled)

25. A method of resource management in a cellular communication system; comprising
allocating a radio resource to a subscriber unit in response to an operator identity associated with a service of the subscriber unit, and
wherein the step of allocating comprises allocating a first radio resource resulting in a first quality of service if the operator corresponds to a cellular communication system operator and a second radio resource resulting in a different quality of service if the operator identity corresponds to a Mobile Virtual Network Operator.

26. A method of resource management as claimed in claim 25 wherein the cellular communication system has a common radio access network resource divided into a first partition for a first operator and a second partition for a second operator and the step of allocating a radio resource comprises allocating resource from the first partition if the operator identity corresponds to the first operator and from the second partition if the operator identity corresponds to the second operator.

27. A method of resource management as claimed in claim 26 wherein the step of allocating a radio resource comprises independently controlling at least one quality of service parameter associated with the first partition of the common radio access network resource in response to a first preference parameter of the first operator, and at least one quality of service parameter associated with the second partition of the common radio access network resource in response to a second preference parameter of the second operator.
